(19) United States
(12) Patent Application Publication
(10) Pub. No.: US 2018/0070175 A1
(43) Pub. Date: Mar. 8, 2018

(54) MANAGEMENT DEVICE AND SOUND ADJUSTMENT MANAGEMENT METHOD, AND SOUND DEVICE AND MUSIC REPRODUCTION METHOD

(71) Applicant: PIONEER CORPORATION, Tokyo (JP)

(72) Inventors: Kensaku OBATA, Kanagawa (JP); Makoto MATSUMARU, Kanagawa (JP); Tsutomu TAKAHASHI, Kanagawa (JP); Hiroshi IWAMURA, Kanagawa (JP)

(21) Appl. No.: 15/561,197

(22) PCT Filed: Mar. 23, 2015
(86) PCT No.: PCT/JP2015/058678

§ 371 Date: Sep. 25, 2017

(51) Int. Cl. H04R 3/04; H04R 3/12; H04S 7/00

(52) U.S. Cl. CPC H04R 3/04; H04S 7/307; H04R 3/12

(57) ABSTRACT

When musical piece is reproduced and outputted, an attribute information acquisition unit acquires attribute information for the musical piece. An attribute information acquisition unit transmits, to a management device, the attribute information as attribute specification information. In the management device, when the attribute specification information has been received, a derivation unit acquires, from adjustment information in a storage unit, octave band information for setting, musical instrument frequency of appearance for setting, and L/R phase difference information for setting that correspond to the attribute specification information. On this basis, the derivation unit generates sound quality adjustment setting value updating information, speaker setting updating information, and signal processing setting updating information, and transmits, to a sound device, these pieces of information as setting updating information. In the sound device which has received the setting updating information, the contents of the setting updating information are set in an adjustment setting unit.

### TECHNICAL FIELD

The present invention relates to a management device, to a sound adjustment management method, and to a sound adjustment management program and to a recording medium upon which such a sound adjustment management program is recorded; and to a sound device, to a music reproduction method, and to a music reproduction program and to a recording medium upon which such a music reproduction program is recorded.

### BACKGROUND ART

From the past, sound devices that reproduce the contents of music have been widespread. And, due to such sound devices being widespread, users in various countries and regions are enabled to listen to music from various countries and regions. Due to the internationalized trend of this sort to listen to music, appropriate audio adjustment has become essential when reproducing and outputting music.

In recent years, as an audio adjustment technique corresponding to this trend for internationalization of music listening, a technique has been proposed (refer to Patent Document #1, hereinafter termed “Prior Art Example”) for reproducing and outputting music matched to the preference of the user, in consideration of the nationality of the user and so on. With this technique of the Prior Art Example, sound technicians generate and set a plurality of audio processing parameters in advance, according to environments of various types or according to user preferences. And, in the state in which a plurality of audio processing parameters of this type have been generated, upon receipt of a user profile or the like sent from a terminal device that specifies the nationality, the race, the age, the type and so on of a user, a server device analyzes the preferences of the user on the basis of the user profile or the like, and selects audio processing parameters on the basis of the results of this analysis. Subsequently, the server device recommends the terminal device to use these audio processing parameters. And it is arranged for the terminal device to perform audio processing while using these audio processing parameters that have thus been recommended, and for a reproduction device to reproduce the results of this audio processing.

### PRIOR ART DOCUMENT

### Patent Documents

Patent Document#1: Japanese Laid-Open Patent Publication 2014-93577.

### SUMMARY OF THE INVENTION

### Problem to be Solved by the Invention

On the other hand, according to research by the inventors of the present application, it has been ascertained that the tendency of the characteristics of music differs according to the country or region in which the music was made. A concrete example will now be explained with reference to FIGS. 1(A) and 1(B). The inventors of the present application have individually analyzed a plurality of musical pieces that were created in various different countries, and FIGS. 1(A) and 1(B) show some results of this analysis as octave band information. Note that this octave band information is information that shows the average values of the results of analysis of a plurality of musical pieces, in which the levels [in dB] at 1000 [Hz] are expressed as values relative to [0].

When FIG. 1(A) and FIG. 1(B) are compared together, it will be understood that there is a tendency for the low band (the band below 100 Hz) to be stronger in the case of the musical pieces that were produced in the country corresponding to FIG. 1(A), as compared to the musical pieces that were produced in the country corresponding to FIG. 1(B). Moreover, it will be understood that there is a tendency for the medium band (the band from 500 Hz to around 1 kHz) to be stronger in the case of the musical pieces that were produced in the country corresponding to FIG. 1(B), as compared to the musical pieces that were produced in the country corresponding to FIG. 1(A). In this manner, from the research carried out by the inventors of the present application, it has been ascertained that the tendency of the characteristics of music differs according to the country or the region in which the music was produced, and it is also considered that, during reproduction of the music, it is necessary to perform audio adjustment according to that country or region.

However, with the technique of the Prior Art Example, no consideration is given to regional attributes corresponding to the music to be reproduced, such as the country or the region in which the music to be reproduced was produced. As a result, it is not possible to perform audio adjustment according to the characteristics of music that correspond to the regional attributes of that music.

Due to this, a technique is desired that is capable of performing audio adjustment processing matched to the characteristics of musical piece in various countries or regions. Responding to this requirement is one of the problems that the present invention is intended to solve.

### Means for Solving the Problems

The invention of claim 1 is a management device, comprising: a storage unit that stores attribute information including region information and adjustment information related to reproduction of musical pieces in mutual correspondence; a first acquisition unit that acquires, from a sound device, region specification information related to a specified region; and a derivation unit that, on the basis of said information stored in said storage unit and said region specification information, derives setting updating information for said sound device, and transmits said setting updating information to said sound device.

And the invention of claim 9 is a sound device, comprising: a first acquisition unit that acquires attribute information including region information related to a region corresponding to a musical piece to be reproduced; a transmission unit that transmits said attribute information to a management device as attribute specification information; a second acquisition unit that acquires, from said management device, setting updating information related to reproduction of said musical piece, derived on the basis of said attribute specification information; and a control unit that controls reproduction of said musical piece on the basis of said setting updating information acquired by said second acquisition unit.

Moreover, the invention of claim 12 is a sound adjustment management method employed by a management device comprising a storage unit that stores attribute information including region information and adjustment information related to reproduction of musical pieces in mutual correspondence, comprising the steps of: acquiring, from a sound device, region specification information related to a specified region; deriving setting updating information for said sound device, on the basis of said information stored in said storage unit and said region specification information; and transmitting said setting updating information to said sound device.

Furthermore, the invention of claim 13 is a sound adjustment management program, wherein it causes a computer included in a management device to execute a sound adjustment management method according to claim 12.

Yet further, the invention of claim 14 is a recording medium, wherein a sound adjustment management program according to claim 13 is recorded thereupon in a form that can be read by a computer in a management device.

Still further, the invention of claim 15 is a music reproduction method employed in a sound device that reproduces a musical piece, comprising the steps of: acquiring attribute information including region information related to a region corresponding to the musical piece to be reproduced; transmitting said attribute information to a management device as attribute specification information; acquiring, from said management device, setting updating information related to the reproduction of said musical piece, derived on the basis of said attribute specification information; and controlling the reproduction of said musical piece on the basis of said setting updating information acquired in said acquiring step of said setting updating information.

Even further, the invention of claim 16 is a music reproduction program, wherein it causes a computer included in a sound device to execute a music reproduction method according to claim 15.

Moreover, the invention of claim 17 is a recording medium, wherein a music reproduction program according to claim 16 is recorded thereupon in a form that can be read by a computer in a sound device.

### BRIEF DESCRIPTION OF DRAWINGS

FIG. 1 is a figure showing examples of octave band information obtained by analysis of musical pieces made in respectively different countries;

FIG. 2 is a block diagram schematically showing the configurations of a management device and of a sound device, according to embodiments of the present invention;

FIG. 3 is a figure for explanation of the contents of analysis information that is stored in a storage unit of the management device of FIG. 2;

FIG. 4 is a figure for explanation of the contents of adjustment information that is stored in the storage unit of the management device of FIG. 2;

FIG. 5 is a figure for explanation of the configuration of an adjustment setting unit of the sound device of FIG. 2;

FIG. 6 is a flow chart for explanation of music reproduction processing performed by the sound device of FIG. 2; and

FIG. 7 is a flow chart for explanation of processing for derivation of setting updating information performed by the management device of FIG. 2.

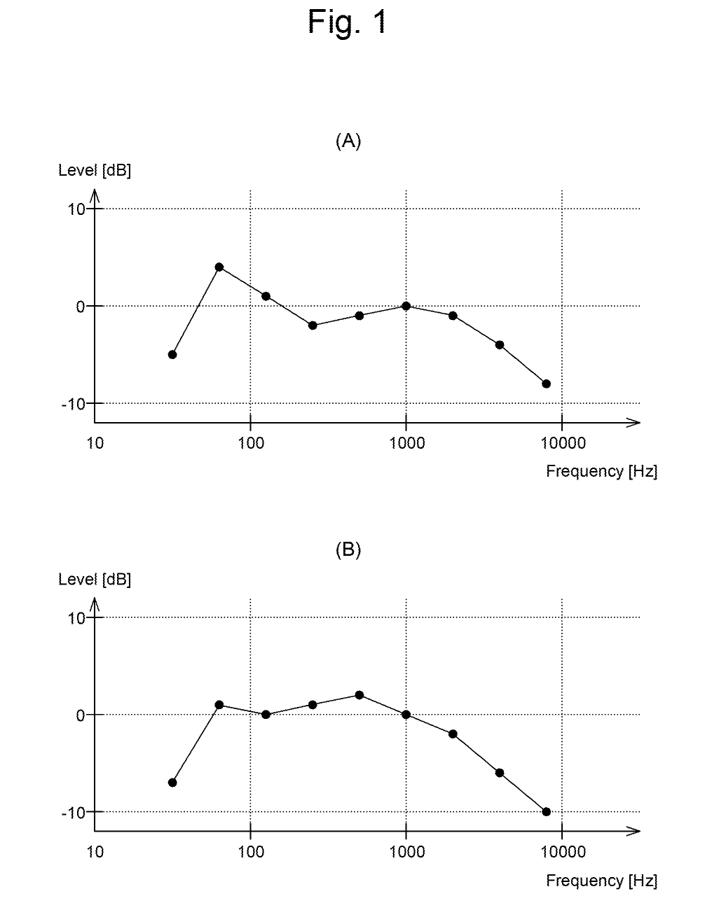

### REFERENCE SIGNS LIST

100: management device

110: transmission and reception unit (first acquisition unit and second acquisition unit of management device)

120: storage unit

130: generation unit

140: derivation unit

200: sound device

239: control unit

270: attribute information acquisition unit (first acquisition unit of sound device)

280: transmission and reception unit (transmission unit and second acquisition unit of sound device)

### Embodiments for Carrying out the Invention

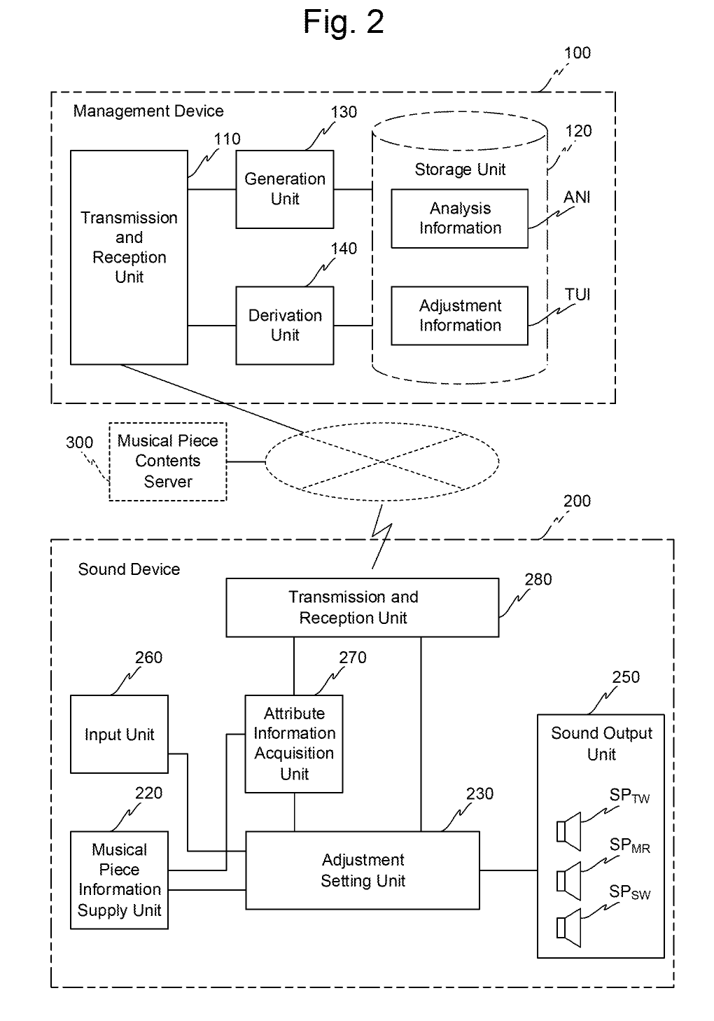

An embodiment of the present invention will now be explained with reference to FIGS. 2 through 7. Note that, in the following explanation and drawings, the same reference symbols are appended to elements that are the same or equivalent, and duplicated explanation will be omitted.

### [Configuration]

The schematic configuration of a management device 100 and of a sound device 200 according to an embodiment are shown in FIG. 2 as a block diagram. In this embodiment, the management device 100 is disposed in a fixed position, for example within a building. Moreover, the sound device 200 is disposed within a vehicle. And the management device 100 and the sound device 200 are capable of communicating with each another via a network. Furthermore, the management device 100 and a musical piece contents server 300 are capable of communicating with each other via the network.

Note that, while the management device 100 is also capable of communicating with other sound devices having configurations similar to that of the sound device 200, only the sound device 200 is shown in FIG. 2, as a representative.

### <Configuration of the Management Device 100>

The configuration of the management device 100 will now be explained.

As shown in FIG. 2, the management device 100 comprises a transmission and reception unit 110 and a storage unit 120. Moreover, the management device 100 comprises a generation unit 130 and a derivation unit 140.

Via the network, the transmission and reception unit 110 periodically receives, from the musical piece contents server 300, musical piece content for analysis (musical piece information) MUI#p (where p=1, . . . ) and musical piece attribute information PPM#p corresponding to this musical piece content MUI#p. And the transmission and reception unit 110 sends this musical piece content MUI#p and this musical piece attribute information PPM#p to the generation unit 130. In this embodiment, information related to the region that corresponds to the musical piece content MUI#p and information specifying the year of production of the musical piece content MUI#p are included in the “musical piece attribute information PPM#p”.

Furthermore, the transmission and reception unit 110 receives attribute specification information PPD from the sound device 200 via the network. And the transmission and reception unit 110 sends this attribute specification information PPD to the derivation unit 140. In this embodiment, information related to the region (the specified region) corresponding to the musical piece reproduced by the sound device 200 (region specification information) and information specifying the year of production of that musical piece are included in the “attribute specification information PPD”.

Yet further, the transmission and reception unit 110 receives setting updating information SEI sent from the derivation unit 140. And the transmission and reception unit 110 transmits this setting updating information SEI to the sound device 200 via the network. In other words, the transmission and reception unit 110 is adapted to fulfil the functions of a first acquisition unit and of a second acquisition unit.

The storage unit 210 is built to include a non-volatile storage device such as a hard disk device or the like. The data stored in the storage unit 120 includes information of various kinds employed by the management device 100. Analysis information ANI and adjustment information TUI are included in this information data. The generation unit 130 and the derivation unit 140 are capable of accessing this storage unit 120.

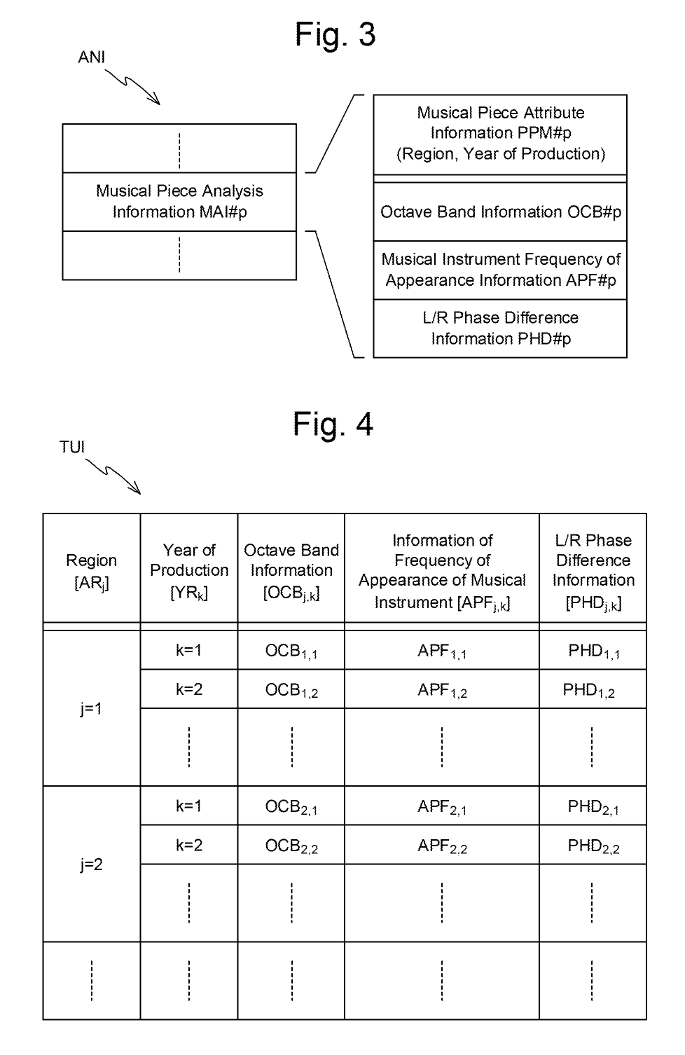

As shown in FIG. 3, musical piece analysis information MAI#p (where p=1, . . . ) , which is the results of analysis of the musical piece that corresponds to the musical piece content MUI#p, is included in the analysis information ANI. Along with the musical piece attribute information PPM#p, octave band information OCB#p, information of frequency of appearance of the musical instrument APF#p, and L/R phase difference information PHD#p are included in this musical piece analysis information MAI#p. This analysis information ANI is generated by the generation unit 130 and is stored in the storage unit 120.

Here, the octave band information OCB#p is the result of performing 1/3 octave band analysis upon the musical piece corresponding to the musical piece content MUI#p, and is information related to its frequency characteristics. In this embodiment, the octave band information OCB#p is information that is expressed as relative values with the level [dB] at 1000 [Hz] being taken as 0.

Moreover, the information of frequency of appearance of musical instrument APF#p is the result of calculating the frequency of appearance of the reproduced sound of a predetermined musical instrument or instruments such as piano or bass or the like in the musical piece corresponding to the musical piece content MUI#p, and is information related to the frequency of appearance of that predetermined musical instrument. In this embodiment, piano and bass are the predetermined musical instruments.

Furthermore, the L/R phase difference information PHD#p is the result of performing phase difference analysis of the left audio signal and the right audio signal of the musical piece corresponding to the musical piece content MUI#p, and is information related to the phase difference between the left audio signal and the right audio signal.

As shown in FIG. 4, for each combination of the region ARⱼ (where j=1, . . . ) and the year of production YRₖ (where k=1, . . . ) of musical pieces corresponding to those regions ARⱼ, octave band information OCB_{j, k}, information of frequency of appearance of the musical instrument APF_{j, k}, and L/R phase difference information PHD_{j, k} are included in the adjustment information TUI. This adjustment information TUI is generated by the generation unit 130 and is stored in the storage unit 120.

Returning to FIG. 2, the generation unit 130 periodically receives musical piece content MUI#p (where p=1, . . . ) and musical piece attribute information PPM#p sent from the transmission and reception unit 110. And, upon receipt of this musical piece content MUI#p and musical piece attribute information PPM#p, the generation unit 130 performs analysis processing upon the musical piece corresponding to the musical piece content MUI#p, and generates the octave band information OCB_{j, k}, the information of frequency of appearance of the musical instrument APF_{j, k}, and the L/R phase difference information PHD_{j, k} described above. And the generation unit 130 also stores this octave band information OCB, this information of frequency of appearance of the musical instrument APF_{j, k}, and this L/R phase difference information PHD_{j, k} in a storage region for analysis information ANI in the storage unit 120 as musical piece analysis information MAI#p, along with the musical piece attribute information PPM#p.

Moreover, the generation unit 130 generates the adjustment information TUI. When generating this adjustment information TUI, the generation unit 130 accesses the analysis information ANI in the storage unit 120, and reads out the octave band information OCB#p and the musical piece attribute information PPM#p of the musical piece analysis information MAI#p. Subsequently the generation unit 130 extracts the octave band information for a plurality of musical pieces that were created in the region ARⱼ (where j=1, . . . ) and in the year of production YRₖ (where k=1, . . . ) from the octave band information OCB#p (where p=1, . . . ). Then the generation unit 130 generates the octave band information OCB_{j, k} by averaging this octave band information that has thus been extracted.

Furthermore, the generation unit 130 reads the information of frequency of appearance of the musical instrument APF#p of the musical piece analysis information MAI#p from the analysis information ANI. Next, the generation unit 130 extracts the information of frequency of appearance of musical instrument for a plurality of musical pieces that were created in the region ARⱼ (where j=1, . . . ) and in the year of production YRₖ (where k=1, . . . ) from the information of frequency of appearance of the musical instrument APF#p (where p=1, . . . ). Subsequently the generation unit 130 generates the information of frequency of appearance of the musical instrument APF_{j, k} by averaging this information of frequency of appearance of the musical instrument that has thus been extracted.

Yet further, the generation unit 130 reads the L/R phase difference information PHD#p of the musical piece analysis information MAI#p from the analysis information ANI. Next, the generation unit 130 extracts the L/R phase difference information for a plurality of musical pieces that were created in the region ARⱼ (where j=1, . . . ) and in the year of production YRₖ (where k=1, . . . ) from the L/R phase difference information PHD#p (where p=1, . . . ). Subsequently the generation unit 130 generates the L/R phase difference information PHD_{j, k} by averaging this L/R phase difference information that has thus been extracted.

Next, the generation unit 130 generates the adjustment information TUI that includes the above described octave band information OCB_{j, k}, the above described information of frequency of appearance of the musical instrument APF, and the above described L/R phase difference information PHD_{j, k}. And the generation unit 130 stores this adjustment information TUI in the storage unit 120.

The derivation unit 140 receives the attribute specification information PPD sent from the transmission and reception unit 110. And, upon receipt of this attribute specification information PPD, the derivation unit 140 accesses the storage unit 120, and reads the octave band information (hereinafter also sometimes termed the octave band information for setting OCB), the information of frequency of appearance of the musical instrument (hereinafter also sometimes termed the information of frequency of appearance of the musical instrument for setting APF), and the L/R phase difference information (hereinafter also sometimes termed the L/R phase difference information for setting PHD) corresponding to this attribute specification information PPD from the adjustment information TUI.

Having read these items of information, first, the derivation unit 140 specifies the frequency characteristic given by the octave band information for setting OCB in the sound quality adjustment setting values. Subsequently, the derivation unit 140 reads the appearance frequencies of piano and bass from the information of frequency of appearance of the musical instrument for setting APF. And, if the frequency of appearance of piano is greater than or equal to the first predetermined value AP1, then the derivation unit 140 raises the gain for the piano sound frequency band in the sound quality adjustment setting values that have been specified by just the first predetermined amount GP1. Moreover, if the frequency of appearance of piano is less than or equal to the second predetermined value AP2, then the derivation unit 140 lowers the gain for the piano sound frequency band in the sound quality adjustment setting values that have been specified by just the second predetermined amount GP2.

Furthermore, if the frequency of appearance of bass is greater than or equal to the first predetermined value AB1, then the derivation unit 140 raises the gain for the bass sound frequency band in the sound quality adjustment setting values that have been specified by just the first predetermined amount GB1. Moreover, if the frequency of appearance of bass is less than or equal to the second predetermined value AB2, then the derivation unit 140 lowers the gain for the bass sound frequency band in the sound quality adjustment setting values that have been specified by just the second predetermined amount GB2.

Here, the first predetermined value AP1, the second predetermined value AP2, the first predetermined amount GP1, and the second predetermined amount GP2 are determined in advance on the basis of experiment, simulation, experience or the like, from the standpoint of changing the audio volume of the piano sound in an appropriate manner according to the frequency of appearance of the piano sound. Moreover, the first predetermined value AB1, the second predetermined value AB2, the first predetermined amount GB1, and the second predetermined amount GB2 are determined in advance on the basis of experiment, simulation, experience or the like, from the standpoint of changing the audio volume of the bass sound in an appropriate manner according to the frequency of appearance of the bass sound.

Furthermore, if the level of a predetermined low sound region in the frequency characteristic given by the octave band information for setting OCB is greater than or equal to a predetermined level value, then the derivation unit 140 generates a speaker setting to set the use of a sub-woofer speaker to “ON”. On the other hand, if the level of the predetermined low sound region is smaller than the predetermined level value, then the derivation unit 140 generates a speaker setting to set the use of the sub-woofer speaker to “OFF”. Here, the range of the predetermined low sound region and the predetermined level value are determined in advance on the basis of experiment, simulation, experience or the like, from the standpoint of enjoying the sound of this low sound region in an appropriate manner.

Moreover if, from the L/R phase difference information for setting PHD, the phase difference between the left audio signal and the right audio signal is smaller than a predetermined phase difference, then the derivation unit 140 generates a signal processing setting to the effect that reverb processing is to be performed. On the other hand, if that phase difference is greater than or equal to the predetermined phase difference, then the derivation unit 140 generates a signal processing setting to the effect that reverb processing is not to be performed. Here, the predetermined phase difference is determined in advance on the basis of experiment, simulation, experience or the like, from the standpoint of imparting a feeling of expansion when the monaural feeling in the left sound and the right sound just as they are is strong.

And the derivation unit 140 sends the sound quality adjustment setting updating information related to the sound quality adjustment setting values in which gain adjustment has been implemented, the speaker setting updating information related to the speaker settings, and the signal processing setting updating information related to the signal processing settings to the transmission and reception unit 110 as setting updating information SEI.

### <Configuration of the Sound Device 200>

The configuration of the sound device 200 will now be explained.

As shown in FIG. 2, the sound device 200 comprises a musical piece information supply unit 220, an adjustment setting unit 230, and a sound output unit 250. Moreover, the sound device 200 comprises an input unit 260, an attribute information acquisition unit 270, and a transmission and reception unit 280.

The musical piece information supply unit 220 generates a musical piece signal MUD on the basis of the contents data for the musical piece for reproduction. And the musical piece information supply unit 220 sends this musical piece signal MUD that has thus been generated to the adjustment setting unit 230. Here, it is arranged for the musical piece information supply unit 220 to send the musical piece signal MUD to the adjustment setting unit 230 upon receipt of a supply command sent from the attribute information acquisition unit 270 or from the adjustment setting unit 230.

Moreover, the musical piece information supply unit 220 reads the region corresponding to the musical piece of this musical piece contents data and the year of production of that musical piece from the musical piece contents data. And the information related to the region corresponding to the musical piece and the year of production information of the musical piece that have been read in this manner are sent to the attribute information acquisition unit 270 as the musical piece for reproduction attribute information.

The adjustment setting unit 230 receives the setting updating information SEI transmitted from the management device 100 via the transmission and reception unit 280, and performs setting updating related to sound processing on the basis of this setting updating information SEI. And, upon receipt of the musical piece signal MUD sent from the musical piece information supply unit 220, the adjustment setting unit 230 performs sound processing upon this musical piece signal MUD, and generates a reproduction audio signal which it sends to the sound output unit 250. The details of the configuration of the adjustment setting unit 230 will be described hereinafter.

In this embodiment, the sound output unit 250 is built to comprise a tweeter speaker SP_{TW}, which is a speaker for treble, a mid-range speaker SP_{MR} which is a speaker for the intermediate sound range, and a sub-woofer speaker SP_{SW} which is a speaker for the ultra-low sound range. This sound output unit 250 receives the reproduction audio signal sent from the adjustment setting unit 230. And the sound output unit 250 outputs musical sounds to the speakers SP_{TW}, SP_{MR}, and SP_{SW} according to the reproduction audio signal.

The input unit 260 is built as a key unit provided to the sound device 200, and/or as a remote input device that comprises a key unit. By the user actuating this input unit 260, settings are implemented for the operating details of the sound device 200, and/or operating commands are issued. For example, the user may perform designation of the musical piece whose contents are to be reproduced by employing the input unit 260.

The attribute information acquisition unit 270 receives the musical piece for reproduction attribute information sent from the musical piece information supply unit 220. And, if no stored attribute information is stored in its interior, then the attribute information acquisition unit 270 stores the musical piece for reproduction attribute information that has thus been acquired as stored attribute information. And the attribute information acquisition unit 270 then sends the musical piece for reproduction attribute information to the transmission and reception unit 280 as attribute specification information PPD.

Moreover, if stored attribute information is stored in its interior, then, each time it receives musical piece for reproduction attribute information, the attribute information acquisition unit 270 makes an identity decision as to whether or not the stored attribute information and the musical piece for reproduction attribute information that has been acquired this time are the same. If the result of this identity decision is affirmative, then the attribute information acquisition unit 270 sends a supply command to the musical piece information supply unit 220.

On the other hand, if the result of the above identity decision is negative, then the attribute information acquisition unit 270 sends a supply standby command to the musical piece information supply unit 220, and also sends the musical piece for reproduction attribute information to the transmission and reception unit 280 as attribute specification information PPD. And the attribute information acquisition unit 270 stores the musical piece for reproduction attribute information internally as stored attribute information. In other words, the attribute information acquisition unit 270 is adapted to fulfil the function of a first acquisition unit.

The transmission and reception unit 280 receives the attribute specification information PPD sent from the attribute information acquisition unit 270. And the transmission and reception unit 280 transmits this attribute specification information PPD to the management device 100 via the network.

Moreover, the transmission and reception unit 280 receives the setting updating information SEI from the management device 100 via the network. And the transmission and reception unit 280 sends this setting updating information SEI to the adjustment setting unit 230. In other words, the transmission and reception unit 280 is adapted to fulfil the functions of a transmission unit and of a second acquisition unit.

### <<Configuration of the Adjustment Setting Unit 230>>

The configuration of the adjustment setting unit 230 will now be explained.

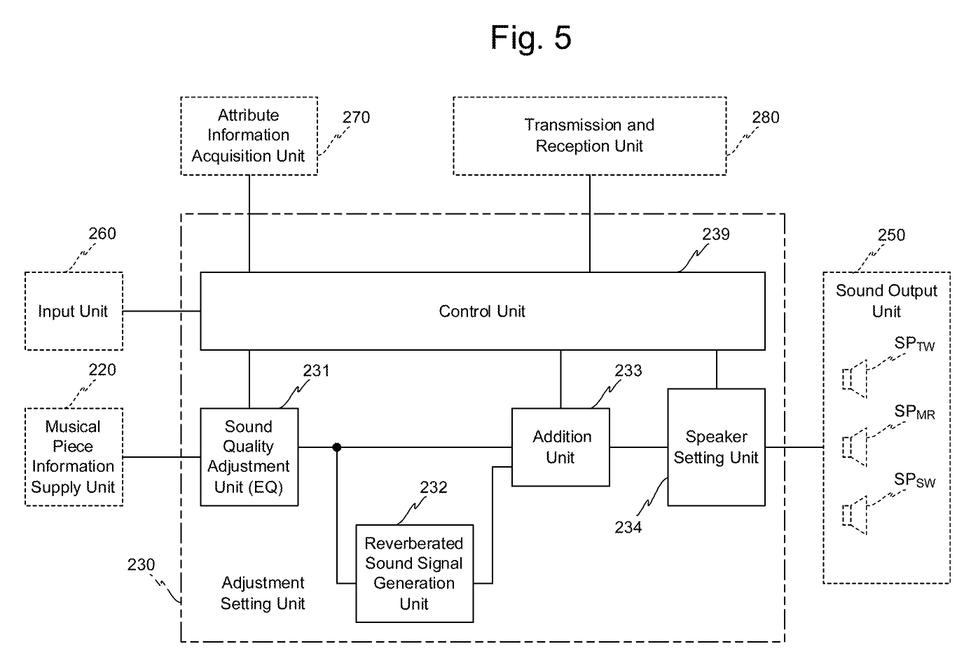

As shown in FIG. 5, the adjustment setting unit 230 comprises a sound quality adjustment unit 231, a reverberated sound signal generation unit 232, and an addition unit 233. Moreover, the adjustment setting unit 230 comprises a speaker setting unit 234 and a control unit 239.

The sound quality adjustment unit 231 receives the sound quality adjustment setting updating information sent from the control unit 239. And the sound quality adjustment unit 231 sets the value given by this sound quality adjustment setting updating information to a sound quality adjustment setting value EQ. When the sound quality adjustment setting value EQ has been set in this manner, the sound quality adjustment unit 231 performs sound quality adjustment processing upon the musical piece signal MUD sent from the musical piece information supply unit 220, and generates a sound quality adjusted signal AFD. And the sound quality adjusted signal AFD that has been generated in this manner is sent to the reverberated sound signal generation unit 232 and to the addition unit 233.

The reverberated sound signal generation unit 232 receives the sound quality adjusted signal AFD sent from the sound quality adjustment unit 231. And the reverberated sound signal generation unit 232 performs predetermined processing upon the sound quality adjusted signal AFD, such as for example processing to generate a reverberated sound signal using a comb filter and an all-pass filter or the like, and thereby generates a reverberated sound signal RVD. The reverberated sound signal RVD that has been generated in this manner is sent to the addition unit 233.

The addition unit 233 receives the sound quality adjusted signal AFD sent from the sound quality adjustment unit 231, and also receives the reverberated sound signal RVD sent from the reverberated sound signal generation unit 232. Moreover, the addition unit 233 receives the signal processing setting updating information sent from the control unit 239. And, when the contents of the signal processing setting updating information is to the effect that reverb processing is to be performed, then the addition unit 233 generates a processed signal PRD by adding together the sound quality adjusted signal AFD and the reverberated sound signal RVD, and sends this processing signal PRD to the speaker setting unit 234. On the other hand, when the contents of the signal processing setting updating information is to the effect that reverb processing is not to be performed, then the sound quality adjusted signal AFD is sent to the speaker setting unit 234 as the processed signal PRD.

The speaker setting unit 234 receives the processed signal PRD sent from the addition unit 233. Moreover, the speaker setting unit 234 receives the speaker setting updating information sent from the control unit 239. And, if the contents of the speaker setting updating information are such as to set the usage of the sub-woofer speaker to “ON”, then the speaker setting unit 234 sends a reproduction audio signal to the sound output unit 250 to the effect that the sound of the musical piece should be outputted from all of the speakers. On the other hand, if the contents of the speaker setting updating information are such as to set the usage of the sub-woofer speaker to “OFF”, then the speaker setting unit 234 sends a reproduction audio signal to the sound output unit 250 to the effect that the sound of the musical piece should be outputted from all of the speakers, with the exception of the sub-woofer speaker SPsw.

The control unit 239 controls the reproduction of the sound of the musical piece on the basis of the musical piece contents data. The control unit 239 receives the setting updating information SEI sent from the transmission and reception unit 280. And, upon receipt of the setting updating information SEI, the control unit 239 sends sound quality adjustment setting updating information that includes the setting updating information SEI to the sound quality adjustment unit 231. Moreover, along with sending signal processing setting updating information that includes the setting updating information SEI to the addition unit 233, the control unit 239 also sends speaker setting updating information that includes the setting updating information SEI to the speaker setting unit 234.

When the setting updating of the setting updating information SEI that has been transmitted from the management device 100 in this manner has been completed, the control unit 239 sends a supply command to the musical piece information supply unit 220.

### [Operation]

The operation performed by the management device 100 and the sound device 200 having the configurations described above working in cooperation will now be explained, with attention being principally focused upon the music reproduction processing performed by the sound device 200 and upon the sound adjustment management processing (i.e. the processing for derivation of the setting updating information) performed by the management device 100.

As a premise, it will be supposed that the generation unit 130 of the management device 100 generates the adjustment information TUI, and that this is stored in the storage unit 120.

### <The Music Reproduction Processing Performed by the Sound Device 200>

First, the music reproduction processing performed by the sound device 200 will be explained.

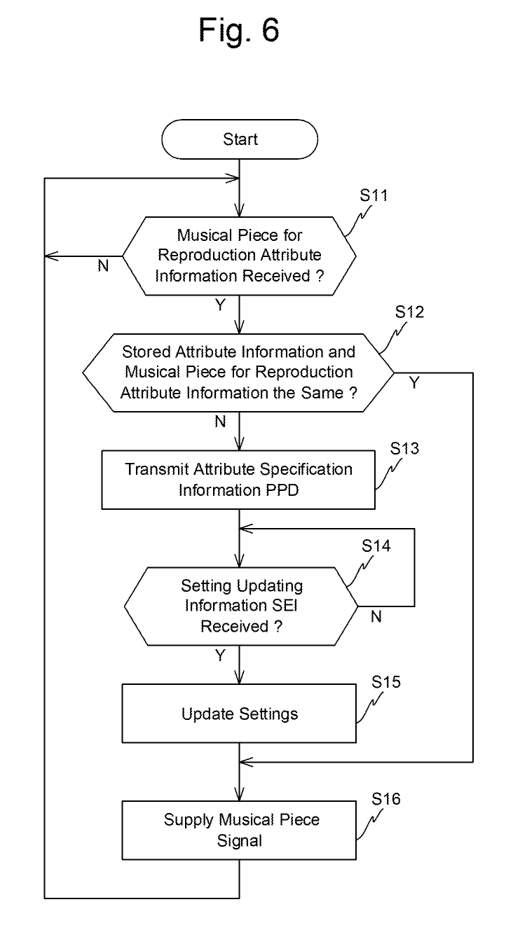

In the music reproduction processing performed by the sound device 200, as shown in FIG. 6, when a new musical piece is to be reproduced, first in a step S11 the attribute information acquisition unit 270 makes a decision as to whether or not musical piece for reproduction attribute information has been sent from the musical piece information supply unit 220. If the result of the decision is negative (N in the step S11), then the processing of the step S11 is repeated.

When, while the step S11 is being repeated, the attribute information acquisition unit 270 acquires new musical piece for reproduction attribute information and the result of the decision in the step S11 becomes affirmative (Y in the step S1), then the flow of control proceeds to a step S12. In the step S12, the attribute information acquisition unit 270 makes a decision as to whether or not this musical piece for reproduction attribute information that has been newly received and the stored attribute information that is being stored internally are the same. Note that, if the attribute information acquisition unit 270 is not storing any stored attribute information internally, then it is arranged for a negative decision to be reached in the step S12. If the result of the decision is affirmative (Y in the step S12), then the attribute information acquisition unit 270 sends the supply command to the musical piece information supply unit 220. And then the flow of control is transferred to a step S16 that will be described hereinafter.

If the result of the decision in the step S12 is negative (N in the step S12), then the flow of control proceeds to a step S13. In the step S13, the musical piece information supply unit 220 sends the musical piece for reproduction attribute information to the transmission and reception unit 280 as attribute specification information PPD. Moreover, the musical piece information supply unit 220 stores the musical piece for reproduction attribute information that has been acquired this time as stored attribute information. And the transmission and reception unit 280 transmits the above mentioned attribute specification information PPD to the management device 100 via the network.

Subsequently, in a step S14 the control unit 239 makes a decision as to whether or not setting updating information SEI has been received. If the result of the decision is negative (N in the step S14), then the processing of the step S14 is repeated.

Note that, when the attribute specification information PPD transmitted from the sound device 200 in the step S13 is received by the management device 100, “derivation processing for setting updating information” that will be described hereinafter is executed by the management device 100. And, when the setting updating information SEI is derived, the management device 100 transmits the setting updating information SEI to the sound device 200 via the network.

When the setting information SEI is received and the result of the decision in the step S14 becomes affirmative (Y in the step S14), the flow of control proceeds to a step S15. In the step S15, the control unit 239 sends the sound quality adjustment setting updating information included in the setting updating information SEI to the sound quality adjustment unit 231. Moreover, the control unit 239 sends the signal processing setting updating information included in the setting updating information SEI to the addition unit 233, and also sends the speaker setting updating information included in the setting updating information SEI to the speaker setting unit 234. And next the control unit 239 sends the supply command to the musical piece information supply unit 220.

Subsequently, in a step S16 the musical piece information supply unit 220 starts supply of the musical piece signal MUD to the sound quality adjustment unit 231 of the adjustment setting unit 230. And then the flow of control returns to the step S11.

When the musical piece signal MUD is supplied to the sound quality adjustment unit 231 in this manner, the sound quality adjustment unit 231 performs sound quality adjustment processing upon the musical piece signal MUD on the basis of the sound quality adjustment setting values EQ that have been updated, and thereby generates a sound quality adjusted signal AFD. And the sound quality adjustment unit 231 sends the sound quality adjusted signal AFD that has thus been generated to the reverberated sound signal generation unit 232 and to the addition unit 233. Upon receipt of the sound quality adjusted signal AFD, the reverberated sound signal generation unit 232 generates a reverberated sound signal RVD from the sound quality adjusted signal AFD, and sends it to the addition unit 233.

Next, according to the signal processing setting updating information, the addition unit 233 sends either the sum of the reverberated sound signal RVD and the sound quality adjusted signal AFD, or the sound quality adjusted signal AFD itself, to the speaker setting unit 234, as the processed signal PRD. Subsequently the speaker setting unit 234 generates a reproduction audio signal according to the speaker setting updating information, and sends it to the sound output unit 250. As a result the sound of the musical piece, matched to the region that corresponds to the musical piece and to its year of production, is outputted from the selected speaker(s) of the sound output unit 250.

Then, the processing of the steps S11 through S16 described above is executed each time reproduction of a new musical piece is to be performed.

### <The Derivation Processing for Setting Updating Information Performed by the Management Device 100>

Next, the processing for derivation of the setting updating information performed by the management device 100 will be explained.

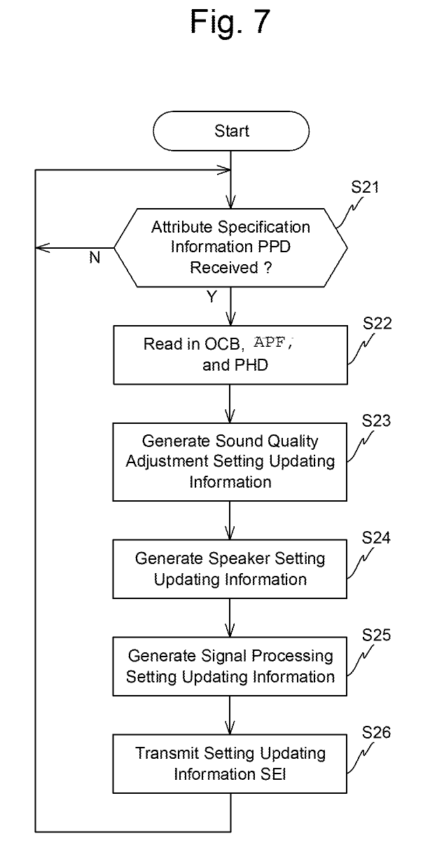

In the processing for derivation of the setting updating information performed by the management device 100, as shown in FIG. 7, first in a step S21 the derivation unit 140 makes a decision as to whether or not the attribute specification information PPD transmitted from the sound device 200 has been received. If the result of the decision is negative (N in the step S21), then the processing of the step S21 is repeated.

When the derivation unit 140 receives new attribute specification information PPD during this repetition of the step S21 and the result of the decision in the step S21 becomes affirmative (Y in the step S21), then the flow of control proceeds to a step S22. In the step S22, the derivation unit 140 accesses the storage unit 120 and, from the adjustment information TUI, reads in the octave band information for setting OCB, the information of frequency of appearance of the musical instrument for setting APF, and the L/R phase difference information for setting PHD, all corresponding to the attribute specification information PPD. And then the flow of control proceeds to a step S23.

In the step S23, the derivation unit 140 generates the sound quality adjustment setting updating information. During the generation of the sound quality adjustment setting updating information, first the derivation unit 140 specifies the frequency characteristics given by the octave band information for setting OCB in the sound quality adjustment setting values. Subsequently, if the frequency of appearance of piano included in the information of frequency of appearance of the musical instrument for setting APF is greater than or equal to the first predetermined value AP1, then the derivation unit 140 raises the gain for the piano sound frequency band in the specified sound quality adjustment setting values by just the first predetermined amount GP1. Moreover, if the frequency of appearance of piano is less than or equal to the second predetermined value AP2, then the derivation unit 140 lowers the gain for the piano sound frequency band in the specified sound quality adjustment setting values by just the second predetermined amount GP2.

Furthermore, if the frequency of appearance of bass is greater than or equal to the first predetermined value AB1, then the derivation unit 140 raises the gain for the bass sound frequency band in the specified sound quality adjustment setting values by just the first predetermined amount GB1. Moreover, if the frequency of appearance of bass is less than or equal to the second predetermined value AB2, then the derivation unit 140 lowers the gain for the bass sound frequency band in the specified sound quality adjustment setting values by just the second predetermined amount GB2.

Subsequently, in a step S24 the derivation unit 140 generates the speaker setting updating information. During the generation of the speaker setting updating information, if the level of a predetermined low sound region in the frequency characteristic given by the octave band information for setting OCB is greater than or equal to the predetermined level value, then the derivation unit 140 generates a speaker setting to put the use of the sub-woofer speaker to “ON”. On the other hand, if the level of the predetermined low sound region is smaller than the predetermined level value, then the derivation unit 140 generates a speaker setting to put the use of the sub-woofer speaker to “OFF”.

Next in a step S25 the derivation unit 140 generates the signal processing setting updating information. During the generation of the signal processing setting information if, from the L/R phase difference information for setting PHD, the phase difference between the left audio signal and the right audio signal is smaller than the predetermined phase difference, then the derivation unit 140 generates a signal processing setting to the effect that reverb processing is to be performed. On the other hand, if that phase difference is greater than or equal to the predetermined phase difference, then the derivation unit 140 generates a signal processing setting to the effect that reverb processing is not to be performed. Then the flow of control proceeds to a step S26.

Subsequently, in the step S26 the derivation unit 140 sends the sound quality adjustment setting value updating information, the speaker setting updating information, and the signal processing setting updating information to the transmission and reception unit 110 as the setting updating information SEI. And the transmission and reception unit 110 transmits the setting updating information SEI to the sound device 200 via the network. Then the flow of control returns to the step S21. Subsequently, the processing of the steps S21 through S26 is repeated.

As has been explained above, in this embodiment, during reproduction and output of a musical piece, before the musical piece information supply unit 220 supplies the musical piece signal MUD to the adjustment setting unit 230, the attribute information acquisition unit 270 acquires the musical piece for reproduction attribute information for the musical piece that is to be reproduced from the musical piece information supply unit 220. And the attribute information acquisition unit 270 makes a decision as to whether or not the musical piece for reproduction attribute information that has been newly acquired and the stored attribute information that is held internally are the same, and sends a supply command to the musical piece information supply unit 220 if the result of the decision is affirmative. On the other hand, if the result of the decision is negative, the attribute information acquisition unit 270 transmits the musical piece for reproduction attribute information to the management device 100 as the attribute specification information PPD.

In the management device 100, upon receipt of the attribute specification information PPD, the derivation unit 140 acquires, from the adjustment information TUI in the storage unit 120, the octave band information for setting OCB, the information of frequency of appearance of the musical instrument for setting APF, and the L/R phase difference information for setting PHD, all of them corresponding to the attribute specification information PPD. Subsequently, the derivation unit 140 specifies the sound quality adjustment setting values of the frequency characteristic given by the octave band information for setting OCB. Moreover, the derivation unit 140 performs gain adjustment for the frequency band of piano sound or for the frequency band of bass sound in the sound quality adjustment setting values that have been specified, on the basis of the frequency of appearance of piano or of bass included in the information of frequency of appearance of the musical instrument for setting APF.

Furthermore, on the basis of the level of the predetermined low sound region in the frequency characteristic given by the octave band information for setting OCB, the derivation unit 140 generates a speaker setting that specifies that the sub-woofer speaker should be set to ON or should be set to OFF. Moreover, on the basis of the L/R phase difference information for setting PHD, the derivation unit 140 generates the signal processing setting that specifies whether reverb processing should be performed or should not be performed. And the derivation unit 140 transmits the sound quality adjustment setting value updating information, the speaker setting updating information, and the signal processing setting updating information to the sound device 200 as the setting updating information SEI.

Upon receipt of the setting updating information SEI by the sound device 200, the control unit 239 of the adjustment setting unit 230 sends the sound quality adjustment setting value updating information to the sound quality adjustment unit 231. Moreover, along with sending the signal processing setting updating information to the addition unit 233, the control unit 239 also sends the speaker setting updating information to the speaker setting unit 234. In this manner, when setting updating is being performed for audio adjustment, the musical piece information supply unit 220 supplies the musical piece signal MUD to the sound quality adjustment unit 231, and the sound quality adjustment unit 231 performs sound quality adjustment processing upon the musical piece signal MUD on the basis of the sound quality adjustment setting values EQ that have been updated, and thereby generates the sound quality adjusted signal AFD. Furthermore, the sound quality adjustment unit 231 sends the sound quality adjustment signal AFD that it has thus generated to the reverberated sound signal generation unit 232 and to the addition unit 233. Next, according to the signal processing setting, the addition unit 233 sends either a signal resulting from adding the reverberated sound signal RVD to the sound quality adjusted signal AFD, or the sound quality adjusted signal AFD itself, to the speaker setting unit 234 as the processed signal PRD. And next the speaker setting unit 234 generates the reproduction audio signal according to the speaker settings, and sends that signal to the sound output unit 250.

Due to this, in this embodiment, sound quality adjustment settings matched to the sound quality characteristics of the region and of the year of production corresponding to the musical piece that is to be reproduced and outputted can be set for the sound device 200. Furthermore, in this embodiment, according to the frequency of appearance of the musical instruments in an average musical piece for the region and for the year of production corresponding to the musical piece which is to be reproduced and outputted, sound quality adjustment settings can be set for the sound device 200 for a mode in which, for musical instruments whose frequency of appearance is high, the gain is set to be high for the frequency bands of those musical instruments, while, for musical instruments whose frequency of appearance is low, the gain is set to be low for the frequency bands of those musical instruments.

Moreover, in this embodiment, on the basis of the frequency characteristics of an average musical piece for the region and for the year of production corresponding to the musical piece which is to be reproduced and outputted, if it is decided that the sound in the low sound region should be emphasized, then it is possible to perform speaker selection that emphasizes the sound output in the low sound region.

Yet further, in this embodiment, it is possible to perform reverb processing if, on the basis of the phase difference between the left audio signal and the right audio signal of an average musical piece for the region and for the year of production corresponding to the musical piece which is to be reproduced and outputted, it is determined that the monaural feeling is strong.

Thus, according to this embodiment, it is possible to perform audio adjustment processing matched to the characteristics of musical piece in various countries or regions.

### [Modification of Embodiment]

The present invention is not to be considered as being limited to the embodiment described above; modifications of various kinds are possible to implement thereto.

For example, in the embodiment described above, the adjustment information stored in the management device was information, for each combination of the region and the year of production of musical pieces corresponding to those regions. By contrast, it would also be acceptable to arrange for the adjustment information to be information, for each combination of the region, the year of production of musical pieces corresponding to those regions and the genre of musical pieces corresponding to those regions.

In this case, it would be possible to arrange for year of production information of the musical piece and genre information of the musical piece, corresponding to the information related to the region associated with the musical piece that is to be reproduced, to be included in the attribute specification information (i.e. in the musical piece for reproduction attribute information).

Moreover, it would also be acceptable to arrange to provide adjustment information in the storage unit for each region and for each music genre corresponding to those regions. In this case, it would be possible to arrange for genre information for the musical piece corresponding to the information related to the region corresponding to the musical piece to be included in the attribute specification information (i.e. in the attribute information of the musical piece for reproduction).

Furthermore, it would be acceptable for the adjustment information in the storage unit to be information associated with each region. In this case, it would be possible to arrange for the attribute specification information (i.e. the attribute information for the musical piece to be reproduced) to consist of information related to the region corresponding to the musical piece.

Yet further, in the embodiment described above, it is arranged to perform “updating of the sound quality adjustment settings”, “updating of the signal processing settings”, and “updating of the speaker settings” while performing updating of the settings of the sound device. By contrast, it would also be acceptable to arrange to perform updating of any one of these three setting, or to perform updating of any combination of two thereof.

Even further, in the embodiment described above, it was arranged for the derivation unit, during the generation of the sound quality adjustment setting updating information, after having specified the frequency characteristic given by the octave band information for setting as the sound quality adjustment setting value, to perform adjustment of the gain in the sound quality adjustment setting values that have been specified according to the frequency of appearance of piano or bass. By contrast, it would also be possible to arrange for the derivation unit to specify the frequency characteristic given by the octave band information for setting as the sound quality adjustment setting value to be transmitted to the sound device, and thereafter not to perform any gain adjustment according to the frequency of appearance of any musical instrument.

Still further it was arranged, in the embodiment described above, after having specified the frequency characteristic given by the octave band information for setting as the sound quality adjustment setting value, to perform adjustment of the gain in the sound quality adjustment setting values that have been specified according to the frequency of appearance of piano or bass. By contrast, it would also be acceptable to arrange to perform sound quality adjustment settings according to a method in which the frequency of appearance of musical instruments other than piano or bass is analyzed, to make the gain high for the frequency band of a musical instrument whose frequency of appearance is high, and to make the gain low for the frequency band of a musical instrument whose frequency of appearance is low.

Moreover it would be possible to perform sound quality adjustment settings according to a method in which, not only musical instruments, but also the frequency of appearance of voice quality (singing method) is analyzed, and the gain is made to be high for the frequency band of a voice quality for which the frequency of appearance is high, while the gain is made to be low for the frequency band of a voice quality whose frequency of appearance is low.

Furthermore, in the embodiment described above, the content of the speaker setting updating information is whether the usage of the sub-woofer speaker is to be ON or OFF. By contrast it would also be acceptable to arrange to decide, on the basis of the frequency characteristic specified by the octave band information for setting, whether or not sound in the treble region should be emphasized, and to set the usage of a tweeter speaker to be ON or OFF on the basis of the result of that decision.

Yet further, it would also be acceptable to decide, on the basis of the frequency characteristic specified by the octave band information for setting, whether or not sounds in the low sound region and in the treble region should be emphasized, to determine upon a combination of the usage of a sub-woofer speaker being ON or OFF and the usage of a tweeter speaker being ON or OFF on the basis of the result of that decision, and to set the result of that determination as the content of the speaker setting updating information.

It would also be acceptable to determine the crossover frequency of the network in the speaker system on the basis of the entire band balance of the frequency characteristic given by the octave band information for setting, and to arrange to reflect the result of this determination in the settings of the sound device.

Still further, in the embodiment described, it was arranged to provide the management device with the storage unit that stored the adjustment information, and for the management device to derive the setting updating information. By contrast, it would also be acceptable to arrange to provide the sound device with a storage unit that stores the adjustment information, and for it to derive the setting updating information on the basis of the attribute specification information.

Furthermore, in the embodiment described above, the content of the attribute specification information is taken as information related to the musical piece to be reproduced. By contrast, it would also be possible to arrange to take the content of the attribute specification information as attributes of the nationality of the user, or of the country or region where he lives. In this case, it would be possible to perform audio adjustment processing matching the attribute of the nationality of the user, or of the country or region where he lives.

Furthermore although, in the embodiment described above, the present invention has been applied to the sound device that is mounted in a vehicle, it would also be possible to apply the present invention to the sound device that is mounted in a different moving body other than a vehicle. It would also be possible to apply the present invention to the sound device that is provided in a home.

It would also be acceptable to arrange to implement the function of the management device of the embodiment described above by building a portion or all of the management device described above as a computer that serves as a calculation means and that comprises a central processing device (CPU: Central Processing Unit) and so on, and by causing that computer to execute a program that is prepared in advance. This program is recorded upon a computer readable recording medium such as a hard disk, a CD-ROM, a DVD or the like, and is read out from the recording medium by the computer and executed. Moreover, it would also be acceptable to arrange for this program to be acquired in the form of being recorded upon a transportable recording medium such as a CD-ROM, a DVD or the like, or to arrange for it to be acquired in the form of being distributed via a network such as the internet or the like.

Moreover, it would also be acceptable to arrange to implement the function of the sound device of the embodiment described above by building a portion or all of the sound device described above (except for the input unit and the sound output unit) as a computer that serves as a calculation means and that comprises a central processing device (CPU: Central Processing Unit) and so on, and by causing that computer to execute a program that is prepared in advance. This program is recorded upon a computer readable recording medium such as a hard disk, a CD-ROM, a DVD or the like, and is read out from the recording medium by the computer and executed. Moreover, it would also be acceptable to arrange for this program to be acquired in the form of being recorded upon a transportable recording medium such as a CD-ROM, a DVD or the like, or to arrange for it to be acquired in the form of being distributed via a network such as the internet or the like.

1-17. (canceled)

18. A management device, comprising:
a storage unit that stores attribute information including region information related to the regions in which musical pieces are produced, and adjustment information related to reproduction of musical pieces corresponding to the attribute information, in mutual correspondence;
a first acquisition unit that acquires, from a sound device, region specification information related to a region in which the musical piece to be reproduced is produced; and
a derivation unit that, on the basis of said information stored in said storage unit and said region specification information, derives setting updating information for said sound device which is adjustment setting adapted to the region in which the reproduced music piece is produced, and transmits said setting updating information to said sound device.

19. The management device according to claim 18, further comprising:
a second acquisition unit that acquires musical piece information and musical piece attribute information corresponding to said musical piece information; and
a generation unit that analyzes said musical piece information acquired by said second acquisition unit and generates musical piece characteristic information specifying characteristics of said musical piece information, and that, on the basis of said musical piece characteristic information and said musical piece attribute information acquired by said second acquisition unit, generates said adjustment information to be stored in said storage unit in correspondence with said attribute information.)

20. The management device according to claim 18, wherein:
said adjustment information is information related to frequency characteristics; and
as said setting updating information, said derivation unit derives sound quality update information that reflects said frequency characteristics corresponding to said region specification information.

21. The management device according to claim 18, wherein:
said adjustment information is a frequency of appearance of a predetermined musical instrument; and
as said setting updating information, said derivation unit derives sound quality update information that reflects the frequency of appearance of said predetermined musical instrument corresponding to said region specification information.

22. The management device according to claim 18, wherein:
said adjustment information is information related to frequency characteristics; and
as said setting updating information, said derivation unit derives optimum speaker configuration update information that reflects said frequency characteristics corresponding to said region specification information.

23. The management device according to claim 18, wherein:
said adjustment information is a phase difference between a left audio signal and a right audio signal; and
as said setting updating information, said derivation unit derives spreading feeling addition processing update information that reflects said phase difference corresponding to said region specification information.

24. The management device according to claim 18, wherein:
at least one of year of production information and genre information is included in said attribute information;
said first acquisition unit further acquires at least one of year of production information and genre information of the musical piece to be reproduced by said sound device; and
said derivation unit derives said setting update information on the basis of at least one of said year of production information and said genre information acquired by said first acquisition unit, in addition to said region specification information.

25. A sound device, comprising:
a first acquisition unit that acquires attribute information including region information related to a region in which a musical piece to be reproduced is produced;
a transmission unit that transmits said attribute information to a management device as attribute specification information;
a second acquisition unit that acquires, from said management device, setting updating information related to reproduction of said musical piece, which is adjustment setting adapted to the region in which said musical piece is produced, derived on the basis of said attribute specification information; and
a control unit that controls reproduction of said musical piece on the basis of said setting updating information acquired by said second acquisition unit.

26. The sound device according to claim 25, wherein a specific region is included in said attribute specification information, and said specific region is a region in which musical piece to be reproduced is produced.

27. The sound device according to claim 25, wherein at least one of year of production information and genre information of said musical piece to be reproduced is included in said attribute specification information.

28. A sound adjustment management method employed by a management device comprising a storage unit that stores attribute information including region information related to the regions in which musical pieces are produced, and adjustment information related to reproduction of musical pieces corresponding to the attribute information, in mutual correspondence, comprising the steps of:
acquiring, from a sound device, region specification information related to a region in which the musical piece to be reproduced is produced;
deriving setting updating information for said sound device which is adjustment setting adapted to the region in which the reproduced music piece is produced, on the basis of said information stored in said storage unit and said region specification information; and
transmitting said setting updating information to said sound device.

29. A non-transient computer readable medium having recorded thereon a sound adjustment management program that, when executed, causes a computer in a management device to execute the sound adjustment management method according to claim 28.
